(19) United States
(12) Patent Application Publication
(10) Pub. No.: US 2026/0265576 A1
(43) Pub. Date: Sep. 10, 2026

(54) Paste

(71) Applicants: VALQUA, LTD., Tokyo (JP); National Institute of Advanced Industrial Science and Technology, Tokyo (JP)

(72) Inventors: Shotaro Ito, Higashi-hiroshima-shi, Hiroshima (JP); Ryosuke Nishi, Gojo-shi, Nara (JP); Tomoaki Yoshiyama, Machida-shi, Tokyo (JP)

(73) Assignee: VALQUA, LTD., Tokyo (JP)

(21) Appl. No.: 19/165,163

(22) PCT Filed: Feb. 21, 2024
(86) PCT No.: PCT/JP2024/006162

§ 371 Date: Sep. 15, 2025

(30) Foreign Application Priority Data
Mar. 16, 2023 (JP) 2023-041755

(51) Int. Cl. C09D 183/08; C08G 77/28; C09D 5/18; C09K 5/14

(52) U.S. Cl. CPC C09D 183/08; C08G 77/28; C09D 5/18; C09K 5/14

(57) ABSTRACT

There is provided an anaerobic paste containing a polysiloxane (A) having a mercapto group, and a redox initiator (B), in which the anaerobic paste thickens at room temperature under conditions of being in contact with a metal member and under anaerobic conditions, and is in a paste-like form or a rubber-like form after thickening.

### CROSS-REFERENCE TO RELATED APPLICATIONS

This application is the United States national phase of International Patent Application No. PCT/JP2024/006162 filed Feb. 21, 2024, and claims priority to Japanese Patent Application No. 2023-041755 filed Mar. 16, 2023, the disclosures of which are hereby incorporated by reference in their entireties.

### BACKGROUND OF THE INVENTION

### Field of the Invention

One embodiment of the present invention relates to a paste.

### Description of Related Art

In members such as sliding members, brake members, and vibration damping and absorbing members, a paste (also referred to as grease) is used between the respective members in order to ensure, for example, a predetermined movement, wear resistance, and seizure resistance of these members.

In addition, a heat-dissipating (thermally conductive) material is used between a heating element and a heat-dissipating member in, for example, an electronic component, in order to efficiently transfer heat from the heating element to the heat-dissipating member. In recent years, with the miniaturization and high output of electronic components such as power modules, the amount of heat generated per unit area from, for example, the electronic component, has become significantly large, and therefore, in order to normally operate, for example, the electronic component, and ensure long-term reliability, a heat-dissipating material having excellent heat dissipation properties is required.

As the heat-dissipating material, there are mainly two types of forms, including a sheet type and a paste type, but the sheet type has a large thermal resistance due to factors such as poor conformability with a mating surface of the heating element or the heat-dissipating member, and the sheet itself requiring a certain thickness. Therefore, a paste type is used due to factors such as its ability to be formed into a thin film, favorable conformability with the mating surface, and excellent heat dissipation performance.

When a viscosity of the paste at the time of coating is low, workability such as coatability and productivity are improved, and a predetermined amount, particularly a small amount of paste is easily disposed at a predetermined location. For example, in the case of the heat-dissipating material, since a thickness of a paste layer can be reduced and the heat dissipation performance can be improved, a low viscosity at the time of coating is required.

On the other hand, the paste is required to stay at a predetermined location (for example, between a heating element and a heat-dissipating member) in order to achieve the purpose required for the paste; however, when the viscosity of the paste at the time of coating is low, since the flow resistance is low, a thermal cycle applied to, for example, electronic components causes a so-called pump-out in which the paste is discharged from the predetermined location, which results in problems such as difficulty in maintaining heat dissipation performance over a long period of time.

In order to solve these problems, in a heat-dissipating paste using a silicone-based material as a base oil, a method has been proposed in which an addition reaction by a platinum catalyst is utilized so that the viscosity is low at the time of coating, and after coating, the base oil is cured to increase flow resistance and suppress pump-out (i.e., JP 2017-75282 A). In addition, methods such as a method of curing by ultraviolet irradiation using a photoactive platinum complex curing catalyst (i.e., JP 2016-089127 A), and a method of curing by heating using an organic peroxide (i.e., JP 2017-226724 A), have also been proposed.

### SUMMARY OF THE INVENTION

For example, the addition reaction type composition described in, for example, JP 2017-75282 A includes a one-liquid type composition and a two-liquid type composition, but in consideration of workability such as complexity of mixing, a one-liquid type composition is preferable, and the one-liquid type composition is also described in JP 2017-75282 A. However, in the case of the one-liquid type composition described in, for example, JP 2017-75282 A, frozen or refrigerated storage is essential, and it is difficult to store and manage the composition.

In addition, since the ultraviolet irradiation type and the heat curing type require an ultraviolet irradiation process and a heating process for curing, respectively, it is necessary to incorporate these processes into a production process for, for example, electronic components, which reduces production efficiency due to the complication and prolongation of the process.

One embodiment of the present invention provides an anaerobic paste which, despite having a low initial viscosity, increases in viscosity at room temperature (without solidifying and while maintaining a paste-like form or a rubber-like form) and can suppress pump-out under conditions of being in contact with a metal member and under conditions in which air is blocked (anaerobic).

Note that the initial viscosity described herein is a viscosity at the time the anaerobic paste is prepared, is a viscosity before the anaerobic paste thickens, and is usually a viscosity during coating.

### Solution to Problem

A configuration example of the present invention is as follows.

[1] An anaerobic paste containing: a polysiloxane (A) having a mercapto group; and a redox initiator (B), in which the anaerobic paste thickens at room temperature under conditions of being in contact with a metal member and under anaerobic conditions, and is in a paste-like form or a rubber-like form after thickening.

[2] The anaerobic paste according to [1], in which an initial shear viscosity at 23° C. is 500 Pa·s or less.

[3] The anaerobic paste according to [1] or [2], in which a functional group ratio represented by the following Formula (1) is 1.0×10⁻³ or less.

$$Functional group ratio = ( a blending amount of the polysiloxane ( A ) / a functional group equivalent of the polysiloxane ( A ) ) \times ( a blending amount of the redox initiator ( B ) / an active oxygen equivalent of the redox initiator ( B ) ) \qquad ( 1 )$$

[4] The anaerobic paste according to any one of [1] to [3], containing a thermally conductive filler (D).

[5] The anaerobic paste according to [4], in which a content of the thermally conductive filler (D) is 30 to 80 vol % with respect to 100 vol % of the anaerobic paste.

### DESCRIPTION OF THE INVENTION

According to one embodiment of the present invention, it is possible to provide an anaerobic paste which, despite having a low initial viscosity, increases in viscosity at room temperature (without solidifying and while maintaining a paste-like form or a rubber-like form) and can suppress pump-out under conditions of being in contact with a metal member and under conditions in which air (oxygen) is blocked (anaerobic). Specifically, for example, the anaerobic paste according to one embodiment of the present invention can thicken in a short time without heating or light irradiation, can increase flow resistance, and can suppress pump-out simply by being disposed and compressed (blocking oxygen) between a heating element and a heat-dissipating member (among them, at least one in contact with the anaerobic paste is a metal member).

In addition, according to one embodiment of the present invention, it is also possible to provide an anaerobic heat-dissipating paste having excellent heat dissipation performance.

### Description of Embodiments

### <<Anaerobic Paste>>

An anaerobic paste according to one embodiment of the present invention (hereinafter, also referred to as “the present paste”) contains a polysiloxane (A) having a mercapto group [hereinafter, also referred to as “component (A)”; the same applies to other components], and a redox initiator (B), thickens at room temperature under conditions of being in contact with a metal member (hereinafter, also referred to as “anaerobic thickening at room temperature”) and under anaerobic conditions, and is in a paste-like form or a rubber-like form after thickening.

The present paste is disposed, for example, between a heating element and a heat-dissipating member (among them, at least one in contact with the anaerobic paste is a metal member), and compressed (blocks oxygen) to block oxygen, such that the redox initiator undergoes cleavage due to the catalytic effect of metal ions from the metal member or mercapto groups, and radicals are generated. It is considered that the generated radicals abstract protons from the mercapto groups, and the crosslinking reaction proceeds, such that the present paste thickens.

Accordingly, the present paste can, at the time of use, thicken in a short time with a simplified process without performing the conventionally necessary processes (for example: heating or light irradiation), can suppress pump-out, and can maintain long-term performance (for example: heat dissipation performance).

In the present invention, the term “paste” is defined as a paste having a thickness of 200 μm or less when 0.2 g of the paste is formed into a 5 mm square and then compressed at 23° C. and a pressure of 1.0 MPa.

The method for measuring the thickness is specifically as described in the following Examples.

In the present invention, the term “rubber” is defined as a rubber that is not in a paste-like form but has elasticity, and has a surface Martens hardness of 10 N/mm² or less as measured by an ultra-micro hardness tester using a triangular pyramid indenter (apex angle: 115°) as a measurement indenter at a maximum test force of 0.3 mN.

Note that, in the present invention, the term “solidification (solidifying)” refers to a state that is neither paste-like nor rubber-like, and can be defined as a state in which a surface Martens hardness exceeds 10 N/mm² as measured by an ultra-micro hardness tester using a triangular pyramid indenter (apex angle: 115°) as a measurement indenter at a maximum test force of 0.3 mN.

The present paste is not solidified even after anaerobic thickening at room temperature, and is in a paste-like form or a rubber-like form after anaerobic thickening at room temperature.

Such a present paste has a thickness of 200 μm or less when the paste thickens at room temperature under conditions of being in contact with a metal member and under anaerobic conditions, specifically, 4 g of the present paste is sandwiched between two copper plates at 23° C., and compressed for 2.5 hours so that the thickness of the paste is 0.4 mm, 0.2 g of the compressed material is formed into a 5 mm square, and then compressed at 23° C. and a pressure of 1.0 MPa, or a surface Martens hardness of a surface of the compressed material is 10 N/mm² or less as measured by an ultra-micro hardness tester using a triangular pyramid indenter (apex angle: 115°) as a measurement indenter at a maximum test force of 0.3 mN.

The method for measuring the thickness is specifically as described in the following Examples.

Note that, in the present invention, the term “thickening” refers to an increase in viscosity after anaerobic thickening at room temperature by at least 10% or more compared to the initial viscosity.

The present paste may be a two or more component type (for example: two or more liquid type) composition containing a first agent containing the component (A) and a second agent containing the component (B), but in consideration of workability such as complexity of mixing, a one-component type (for example: one-liquid type) composition is preferable.

### <Polysiloxane (A)>

The component (A) is not particularly limited as long as it is a polysiloxane having a mercapto group (—SH). Note that the component (A) may have a functional group other than a mercapto group (for example: a group having an ethylenically unsaturated bond [for example: a vinyl group or a (meth)acryloyl group]).

By using such a component (A), it is possible to easily obtain a paste which has excellent heat resistance, does not solidify even after anaerobic thickening at room temperature, and is in a paste-like form or a rubber-like form after anaerobic thickening at room temperature.

The component (A) used in the present paste may be one kind or two or more kinds.

The bonding position of the mercapto group is not particularly limited, and may be a so-called side-chain type, terminal type (including mono-terminal type and bi-terminal type), or side-chain bi-terminal type, but is preferably a side-chain type or a bi-terminal type, and more preferably a side-chain type.

The component (A) is an organopolysiloxane in which an organic group is bonded to a silicon atom, and is preferably a polysiloxane having a mercapto group in at least a part of the organopolysiloxane.

Examples of the organic group bonded to the silicon atom include a linear alkyl group, a branched alkyl group, a cyclic alkyl group, an aryl group, an aralkyl group, a halogenated alkyl group, and an alkoxy group.

Examples of the linear alkyl group include groups having 1 to 20 carbon atoms, such as a methyl group, an ethyl group, a propyl group, a hexyl group, an octyl group, and a decyl group, and preferably 1 to 6 carbon atoms.

Examples of the branched alkyl group include groups having 3 to 20 carbon atoms, such as an isopropyl group, an isobutyl group, a t-butyl group, and a 2-ethylhexyl group, and preferably 3 to 6 carbon atoms.

Examples of the cyclic alkyl group include groups having 3 to 20 carbon atoms such as a cyclopentyl group and a cyclohexyl group.

Examples of the aryl group include groups having 6 to 20 carbon atoms such as a phenyl group and a tolyl group.

Examples of the aralkyl group include groups having 7 to 20 carbon atoms such as a benzyl group, a 2-phenylethyl group, and a 2-methyl-2-phenylethyl group.

Examples of the halogenated alkyl group include groups having 1 to 20 carbon atoms, such as a 3,3,3-trifluoropropyl group, a 2-(nonafluorobutyl)ethyl group, and a 2-(heptadecafluorooctyl)ethyl group, and preferably 1 to 6 carbon atoms.

Examples of the alkoxy group include groups having 1 to 20 carbon atoms, preferably 1 to 6 carbon atoms, such as a methoxy group and an ethoxy group.

As the organic group bonded to the silicon atom, a linear alkyl group and an aryl group are preferable, a linear alkyl group having 1 to 6 carbon atoms and an aryl group are more preferable, and a methyl group and a phenyl group are particularly preferable.

That is, as the structure other than the portion having a mercapto group in the organopolysiloxane, at least one polysiloxane structure selected from dimethylpolysiloxane, methylphenylpolysiloxane, and diphenylpolysiloxane is preferable, and a dimethylpolysiloxane structure is more preferable.

The mercapto group may be directly bonded to a silicon atom, or may be bonded to a silicon atom via an organic group bonded to the silicon atom.

The molecular structure of the component (A) is not particularly limited, and examples thereof include linear, branched, partially branched linear, and dendritic (dendrimer-like) structures, and a linear structure and a partially branched linear structure are preferable. The component (A) may be a single polymer having such a molecular structure, a copolymer having such a molecular structure, or a mixture of two or more of these polymers.

Specific examples of the component (A) include a polysiloxane represented by the following Formula (2).

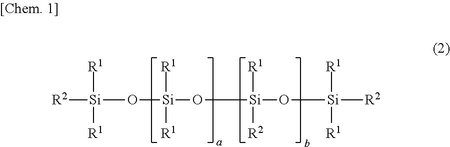

In Formula (2), R¹ and R² are each independently an unsubstituted or substituted monovalent hydrocarbon group, a mercapto group, an alkoxy group, or —R—SH (R is a hydrocarbon group having 1 to 20 carbon atoms), and the sum of a and b is an integer of 2 to 500. Provided that at least one of R¹ and R² in Formula (2) contains a mercapto group or —R—SH, a plurality of R's present in Formula (2) may be the same as or different from each other, and a plurality of R²s present in Formula (2) may be the same as or different from each other.

The unsubstituted or substituted monovalent hydrocarbon group in R¹ and R² is preferably an unsubstituted or substituted monovalent hydrocarbon group having 1 to 20 carbon atoms, and examples thereof include groups similar to the groups (other than an alkoxy group) exemplified as the organic group bonded to the silicon atom. Among them, a monovalent hydrocarbon group having 1 to 6 carbon atoms is preferable, and an alkyl group having 1 to 6 carbon atoms and an aryl group are more preferable.

Examples of the alkoxy group in R¹ and R² include groups similar to the alkoxy group exemplified as the organic group bonded to the silicon atom.

In —R—SH, R is a hydrocarbon group having 1 to 20 carbon atoms, and examples of R include groups obtained by removing one hydrogen atom from the groups exemplified as the organic group bonded to the silicon atom (groups other than a halogenated alkyl group and an alkoxy group).

As the component (A), one synthesized by a conventionally known method may be used, or a commercially available product may be used.

A shear viscosity at 23° C. of the component (A) measured with a cone-plate type viscometer (rotational speed: 0.5 rpm) is preferably 0.005 to 60.00 Pa·s and more preferably 0.01 to 5.00 Pa·s.

When the viscosity of the component (A) is within the above range, a paste having a low initial viscosity and excellent coatability can be easily obtained. In addition, when such a paste having a low initial viscosity is a heat-dissipating paste, for example, a paste layer having a small thickness can be easily formed at a predetermined location such as between a heating element and a heat-dissipating member, and a paste layer that easily conforms to a mating surface of, for example, a heating element or a heat-dissipating member can be easily formed. Therefore, the thermal resistance can be reduced by the paste layer, and, for example, an electronic component having excellent heat dissipation properties can be easily obtained.

A functional group equivalent of the component (A) is preferably 1,000 to 50,000 g/mol and more preferably 1,500 to 35,000 g/mol, from the viewpoint that, for example, it is possible to easily obtain a paste having a viscosity sufficient to suppress pump-out after anaerobic thickening at room temperature, not solidifying even after anaerobic thickening at room temperature, and remaining in a paste-like form or a rubber-like form even after anaerobic thickening at room temperature.

Note that the functional group of the component (A) refers to a group that reacts with radicals generated from the redox initiator, and specific examples thereof include a mercapto group and the functional group other than the mercapto group.

In addition, as the component (A), it is desirable to use a polysiloxane (A1) having a functional group equivalent of preferably 1,000 to 5,000 g/mol and more preferably 1,500 to 5,000 g/mol and a polysiloxane (A2) having a functional group equivalent of preferably 15,000 to 50,000 g/mol and more preferably 20,000 to 35,000 g/mol, from the viewpoint that, for example, it is possible to easily obtain a paste having a viscosity sufficient to suppress pump-out after anaerobic thickening at room temperature, not solidifying even after anaerobic thickening at room temperature, and remaining in a paste-like form or a rubber-like form even after anaerobic thickening at room temperature.

In the case of using such polysiloxanes (A1) and (A2), a ratio of the polysiloxane (A2) with respect to 100 mass % of the total of these polysiloxanes is preferably 50.0 to 99.5 mass % and more preferably 75.0 to 99.0 mass %.

A number average molecular weight (Mn) of the component (A) measured by gel permeation chromatography (GPC) is preferably 3,000 to 50,000 and more preferably 15,000 to 25,000, from the viewpoint that, for example, it is possible to easily obtain a paste which can suppress pump-out after anaerobic thickening at room temperature, despite having a low initial viscosity.

When the present paste does not contain the following component (D), the content of the component (A) in the present paste is preferably 40.0 to 98.0 mass % and more preferably 60.0 to 95.0 mass % with respect to 100 mass % of the present paste, and when the present paste contains the following component (D), the content of the component (A) in the present paste is preferably 5.0 to 40.0 mass % and more preferably 10.0 to 30.0 mass % with respect to 100 mass % of the present paste, from the viewpoint that, for example, a paste having an excellent balance among heat resistance, low initial viscosity, and suppression of pump-out can be easily obtained.

When the present paste contains the following component (C), the content of the component (A) in the present paste is preferably 40.0 to 99.0 mass %, more preferably 70.0 to 99.0 mass %, and still more preferably 85.0 to 98.5 mass %, with respect to 100 mass % of the total of the components (A) and (C) in the present paste, from the viewpoint that, for example, a paste having an excellent balance among heat resistance, low initial viscosity, and suppression of pump-out can be easily obtained.

### <Redox Initiator (B)>

The component (B) is not particularly limited as long as it is a redox initiator, and a conventionally known redox initiator can be used.

Since the component (A) having a mercapto group acts as a reducing agent, the component (B) is preferably a component (oxidizing agent) capable of causing a redox reaction by the component (A) to generate radicals.

The component (B) used in the present paste may be one kind or two or more kinds.

Examples of the component (B) include an organic peroxide, a persulfate, permanganic acid, a permanganate, manganese triacetate, cerium ammonium nitrate, cerium ammonium sulfate, bromic acid, a bromate, and hydrogen peroxide. Among them, an organic peroxide is preferable.

Examples of the organic peroxide include hydroperoxides such as t-butyl hydroperoxide, t-amyl hydroperoxide, cumene hydroperoxide, 1,1,3,3-tetramethylbutyl hydroperoxide, p-menthane hydroperoxide, and diisopropylbenzene hydroperoxide; dihydroperoxides such as 2,5-dimethylhexane-2,5-dihydroperoxide; ketone peroxides such as acetylacetone peroxide and methyl ethyl ketone peroxide; peroxyesters such as t-butyl peroxybenzoate; disuccinic acid peroxide; and glutaric acid peroxide.

Examples of the persulfate include ammonium persulfate, sodium persulfate, and potassium persulfate.

Examples of the permanganate include ammonium permanganate, alkali metal salts of permanganic acid (for example: potassium permanganate), and alkaline earth metal salts of permanganic acid.

Examples of the bromate include ammonium bromate, alkali metal salts of bromic acid, and alkaline earth metal salts of bromic acid.

A functional group ratio represented by the following Formula (1) in the present paste is preferably 1.0×10⁻³ or less, more preferably 5.0×10⁻⁴ or less, and still more preferably 3.0×10⁻⁴ or less.

When the present paste is a one-component type paste, the paste tends to easily thicken during storage, but when the functional group ratio is within the above range, a paste having excellent storage stability tends to be obtained easily. When the functional group ratio exceeds the above range, a paste having excellent storage stability (storage preservability) may not be easily obtained.

In addition, the functional group ratio represented by the following Formula (1) in the present paste is preferably 1.0×10⁻⁶ or more, and more preferably 1.0×10⁻⁵ or more, from the viewpoint of easily obtaining a paste that can undergo anaerobic thickening at room temperature and suppress pump-out.

$$Functional group ratio = ( Blending amount of component ( A ) / Functional group equivalent of component ( A ) ) \times ( Blending amount of component ( B ) / Active oxygen equivalent of component ( B ) ) \qquad ( 1 )$$

In Formula (1), the blending amount of the component (A) is 100 parts by mass, and the blending amount of the component (B) is the blending amount of the component (B) with respect to 100 parts by mass of the blending amount of the component (A).

Note that, as the component (A), for example, when the component (A) having a functional group equivalent of a g/mol is used in a blending amount of x1 mass %, and the component (A) having a functional group equivalent of b g/mol is used in a blending amount of x2 mass % (where x1+x2=100), the “blending amount of component (A)/functional group equivalent of component (A)” in Formula (1) is expressed as “(x1/a+x2/b)”. The same applies to the case of using two or more kinds as the component (A) or (B).

Note that the “blending amount of the component (A)” is, for example, 100×z/100 when a commercially available product having a purity (active ingredient amount) of z mass % is used at 100 mass % as the component (A). The same applies to the “blending amount of the component (B)”.

The content of the component (B) in the present paste is preferably an amount that satisfies Formula (1), but is preferably 0.05 to 30 parts by mass, more preferably 0.5 to 20 parts by mass, and particularly preferably 1 to 10 parts by mass, with respect to 100 parts by mass of the component (A) in the present paste, from the viewpoint that, for example, it is possible to easily obtain a paste which undergoes anaerobic thickening at room temperature, can suppress pump-out, and further has excellent storage stability.

### <Other Components>

The present paste may contain other components other than the components (A) and (B) as necessary as long as the effects of the present invention are not impaired.

Examples of the other components include a compound (C) having two or more ethylenically unsaturated bonds in one molecule other than the component (A); a thermally conductive filler (D); a stabilizer; a catalyst; a plasticizer such as fluorine-based or silicone-based oil; a silane coupling agent; a surfactant; a solvent; a dispersant; a flame retardant; and a pigment.

Each of the other components may be used alone or two or more kinds.

It is preferable that the present paste does not contain a platinum-based catalyst from the viewpoint of easily obtaining a paste having a long pot life, for example.

The conventional paste uses a platinum-based catalyst, but when a platinum-based catalyst is used, a pot life is short, and the paste cannot be stored for a long period of time.

Note that the phrase “does not contain a platinum-based catalyst” means that the content of the platinum-based catalyst with respect to 100 parts by mass of the component (A) is, for example, 0.0001 parts by mass or less, and the lower limit is preferably 0 parts by mass.

### [Compound (C) Having Two or More Ethylenically Unsaturated Bonds in One Molecule]

The component (C) is not particularly limited as long as it is a compound having two or more ethylenically unsaturated bonds in one molecule other than the component (A), and a conventionally known compound (co-crosslinking agent) can be used.

By using the component (C), a paste having more excellent suppression of pump-out after anaerobic thickening at room temperature can be easily obtained.

The component (C) used in the present paste may be one kind or two or more kinds.

The number of ethylenically unsaturated bonds in the component (C) may be two, but is preferably three or more and more preferably three to six from the viewpoint that, for example, pump-out can be further suppressed.

Two or more ethylenically unsaturated bonds contained in the component (C) may be the same as or different from each other. That is, the compound (C) may have two or more kinds of ethylenically unsaturated bonds.

Examples of the group having an ethylenically unsaturated bond include alkenyl groups having 2 to 8 carbon atoms such as a vinyl group, a methylvinyl group, an allyl group, a propenyl group, an isopropenyl group, a butenyl group, a pentenyl group, a hexenyl group, and a heptenyl group, a vinylphenyl group, a (meth)acryloyl group, an allyloxy group, a styryl group, a propargyl group, and a maleimide group. Among them, an alkenyl group having 2 to 8 carbon atoms and a (meth)acryloyl group are preferable, an alkenyl group having 2 to 4 carbon atoms and a (meth)acryloyl group are more preferable, and a vinyl group and a (meth)acryloyl group are particularly preferable.

Examples of the component (C) include a polysiloxane having two or more ethylenically unsaturated bonds in one molecule;
polyfunctional (meth)acrylate compounds such as ethylene glycol di(meth)acrylate, diethylene glycol di(meth)acrylate, polyethylene glycol di(meth)acrylate, propylene glycol di(meth)acrylate, butylene glycol di(meth)acrylate, hexanediol di(meth)acrylate, cyclohexanedimethanol di(meth)acrylate, bisphenol A alkylene oxide di(meth)acrylate, bisphenol F alkylene oxide di(meth)acrylate, trimethylol propane tri(meth)acrylate, ditrimethylol propane tetra(meth)acrylate, glycerin tri(meth)acrylate, pentaerythritol tri(meth)acrylate, pentaerythritol tetra(meth)acrylate, dipentaerythritol penta(meth)acrylate, dipentaerythritol hexa(meth)acrylate, tripentaerythritol hepta(meth)acrylate, tripentaerythritol octa(meth)acrylate, ethylene oxide adduct trimethylol propane tri(meth)acrylate, ethylene oxide adduct ditrimethylol propane tetra(meth)acrylate, ethylene oxide adduct pentaerythritol tetra(meth)acrylate, ethylene oxide adduct dipentaerythritol hexa(meth)acrylate, propylene oxide adduct trimethylol propane tri(meth)acrylate, propylene oxide adduct ditrimethylol propane tetra(meth)acrylate, propylene oxide adduct pentaerythritol tetra(meth)acrylate, propylene oxide adduct dipentaerythritol hexa(meth)acrylate, ε-caprolactone adduct trimethylol propane tri(meth)acrylate, ε-caprolactone adduct ditrimethylol propane tetra(meth)acrylate, ε-caprolactone adduct pentaerythritol tetra(meth)acrylate, ε-caprolactone adduct dipentaerythritol hexa(meth)acrylate, dipentaerythritol penta(meth)acrylate succinic acid modified product, pentaerythritol tri(meth)acrylate succinic acid modified product, dipentaerythritol penta(meth)acrylate phthalic acid modified product, pentaerythritol tri(meth)acrylate phthalic acid modified product, tri((meth)acryloyloxyethyl)isocyanurate, and alkylene oxide adduct tri((meth)acryloyloxyethyl)isocyanurate;
polyfunctional vinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, bisphenol F alkylene oxide divinyl ether, trimethylol propane trivinyl ether, ditrimethylol propane tetravinyl ether, glycerin trivinyl ether, pentaerythritol tetravinyl ether, dipentaerythritol pentavinyl ether, dipentaerythritol hexavinyl ether, ethylene oxide adduct trimethylol propane trivinyl ether, ethylene oxide adduct ditrimethylol propane tetravinyl ether, ethylene oxide adduct pentaerythritol tetravinyl ether, and ethylene oxide adduct dipentaerythritol hexavinyl ether;
vinyl ether group-containing (meth)acrylic acid esters such as 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 4-vinyloxycyclohexyl (meth)acrylate, 5-vinyloxypentyl (meth)acrylate, 6-vinyloxyhexyl (meth)acrylate, 4-vinyloxymethylcyclohexylmethyl (meth)acrylate, p-vinyloxymethylphenylmethyl (meth)acrylate, 2-(vinyloxyethoxy)ethyl (meth)acrylate, and 2-(vinyloxyethoxyethoxyethoxy)ethyl (meth)acrylate;
polyfunctional allyl compounds such as ethylene glycol diallyl ether, diethylene glycol diallyl ether, polyethylene glycol diallyl ether, propylene glycol diallyl ether, butylene glycol diallyl ether, hexanediol diallyl ether, bisphenol A alkylene oxide diallyl ether, bisphenol F alkylene oxide diallyl ether, trimethylol propane triallyl ether, ditrimethylol propane tetraallyl ether, diallyl phthalate, glycerin triallyl ether, pentaerythritol tetraallyl ether, dipentaerythritol pentaallyl ether, dipentaerythritol hexaallyl ether, ethylene oxide adduct trimethylol propane triallyl ether, ethylene oxide adduct ditrimethylol propane tetraallyl ether, ethylene oxide adduct pentaerythritol tetraallyl ether, ethylene oxide adduct dipentaerythritol hexaallyl ether, triallyl isocyanurate, triallyl cyanurate, triallyl formal, triallyl trimellitate, and tetraallylterephthalamide;
allyl group-containing (meth)acrylic acid esters such as allyl (meth)acrylate;
polyfunctional (meth)acrylamide compounds such as N,N-ethylenebis(meth)acrylamide;
polyfunctional propargyl compounds such as dipropargyl terephthalate;
polyfunctional maleimide compounds such as N,N′-m-phenylenebismaleimide;
polyfunctional urethane (meth)acrylates obtained by the reaction of polyfunctional isocyanates such as tolylene diisocyanate, isophorone diisocyanate, and xylylene diisocyanate with hydroxyl group-containing (meth)acrylic acid esters such as 2-hydroxyethyl (meth)acrylate and 2-hydroxypropyl (meth)acrylate; and
polyfunctional aromatic vinyl compounds such as divinylbenzene.

Among them, a polyfunctional (meth)acrylate compound, a polyfunctional allyl compound, and a polyfunctional (meth)acrylamide compound are preferable, a trifunctional or higher polyfunctional (meth)acrylate compound and a trifunctional or higher polyfunctional allyl compound are more preferable, and triallyl isocyanurate, trimethylol propane tri(meth)acrylate are particularly preferable, from the viewpoint that, for example, a paste having excellent reactivity and excellent heat resistance can be easily obtained.

Examples of the polysiloxane containing two or more ethylenically unsaturated bonds in one molecule include dimethylpolysiloxane capped at both molecular chain terminals with dimethylvinylsiloxy groups, dimethylpolysiloxane capped at both molecular chain terminals with methylphenylvinylsiloxy groups, dimethylsiloxane-methylphenylsiloxane copolymers capped at both molecular chain terminals with dimethylvinylsiloxy groups, dimethylsiloxane-methylvinylsiloxane copolymers capped at both molecular chain terminals with dimethylvinylsiloxy groups, dimethylsiloxane-methylvinylsiloxane copolymers capped at both molecular chain terminals with silanol groups, dimethylsiloxane-methylvinylsiloxane-methylphenylsiloxane copolymers capped at both molecular chain terminals with silanol groups, dimethylsiloxane-methylvinylsiloxane copolymers capped at both molecular chain terminals with trimethylsiloxy groups, methyl(3,3,3-trifluoropropyl)polysiloxane capped at both molecular chain terminals with dimethylvinylsiloxy groups, and organosiloxane copolymers composed of a siloxane unit represented by Formula: (CH₃)₃SiO_{1/2}, a siloxane unit represented by Formula: (CH₃)₂(CH₂═CH)SiO_{1/2}, a siloxane unit represented by Formula: CH₃SiO_{3/2}, and a siloxane unit represented by Formula:

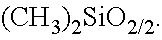

Specific examples of the polysiloxane having two or more ethylenically unsaturated bonds in one molecule include a compound represented by the following Formula (3).

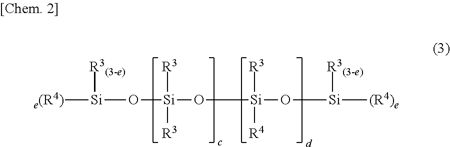

In Formula (3), each R³ is independently an unsubstituted or substituted monovalent hydrocarbon group, each R⁴ is independently an alkyl group, an alkoxyalkyl group, an alkenyl group, or an acyl group, the sum of c and d is an integer of 2 to 1,000, and e is an integer of 1 to 3. Provided that at least two of R³ and R⁴ in Formula (3) contain the ethylenically unsaturated bond, the plurality of R³s present in Formula (3) may be the same as or different from each other, and the plurality of R⁴s present in Formula (3) may be the same as or different from each other.

Each R³ is independently an unsubstituted or substituted monovalent hydrocarbon group having preferably 1 to 10 carbon atoms, and examples thereof include groups which are the same as the groups exemplified as the organic group bonded to the silicon atom (excluding halogenated alkyl groups and alkoxy groups), and an alkenyl group. Among them, a monovalent hydrocarbon group having 1 to 6 carbon atoms is preferable, and an alkenyl group, an aryl group, and an alkyl group having 1 to 3 carbon atoms are more preferable.

Examples of the alkyl group in R⁴ include a linear alkyl group, a branched alkyl group, and a cyclic alkyl group which are the same as the groups exemplified as the organic group bonded to the silicon atom.

Examples of the alkoxyalkyl group in R⁴ include groups having 2 to 10 carbon atoms such as a methoxyethyl group and a methoxypropyl group.

Examples of the alkenyl group in R³ and R⁴ include the same alkenyl group as the group exemplified as the ethylenically unsaturated bond.

Examples of the acyl group in R⁴ include groups having 2 to 10 carbon atoms such as an acetyl group and an octanoyl group.

The sum of c and d is preferably an integer of 10 to 50, and e is preferably 1.

A functional group (ethylenically unsaturated bond) equivalent of the component (C) is preferably 4 to 25,000 g/mol, more preferably 50 to 25,000 g/mol, and still more preferably 75 to 130 g/mol, from the viewpoint that, for example, it is possible to easily obtain a paste having a viscosity sufficient to suppress pump-out after anaerobic thickening at room temperature, not solidifying even after anaerobic thickening at room temperature, and remaining in a paste-like form or a rubber-like form even after anaerobic thickening at room temperature.

The component (C) is preferably used so that a functional group ratio represented by the following Formula (4) is preferably 3 or less, more preferably 0.01 to 3, still more preferably 0.01 to 2, even more preferably 0.015 to 1, and particularly preferably 0.02 to 0.8, from the viewpoint that, for example, it is possible to easily obtain a paste having a viscosity sufficient to suppress pump-out after anaerobic thickening at room temperature, not solidifying even after anaerobic thickening at room temperature, and remaining in a paste-like form or a rubber-like form even after anaerobic thickening at room temperature.

$$Functional group ratio = ( Blending amount of component ( A ) / Functional group equivalent of component ( A ) ) \times ( Blending amount of component ( C ) / Functional group equivalent of component ( C ) ) \qquad ( 4 )$$

In Formula (4), the blending amount of the component (A) is 100 parts by mass, and the blending amount of the component (C) is the blending amount of the component (C) with respect to 100 parts by mass of the blending amount of the component (A).

Note that, as the component (A), for example, when the component (A) having a functional group equivalent of a g/mol is used in a blending amount of x1 mass %, and the component (A) having a functional group equivalent of b g/mol is used in a blending amount of x2 mass % (where x1+x2=100), the “blending amount of component (A)/functional group equivalent of component (A)” in Formula (4) is expressed as “(x1/a+x2/b)”. The same applies to the case of using two or more kinds as the component (A) or (C).

Note that the blending amount of the component (A) is, for example, 100×z/100 when a commercially available product having a purity (active ingredient amount) of z mass % is used at 100 mass % as the component (A). The same applies to the blending amount of the component (C).

The content of the component (C) is preferably an amount that satisfies Formula (4), but the content of the component (C) in the present paste is preferably as small as possible. In this respect, the content of the component (C) with respect to 100 mass % of the present paste is preferably 0.2 to 50 mass %, more preferably from 0.3 to 15 mass %, and still more preferably from 0.5 to 5.5 mass %, from the viewpoint that, for example, it is possible to easily obtain a paste having a viscosity sufficient to suppress pump-out after anaerobic thickening at room temperature, not solidifying even after anaerobic thickening at room temperature, and remaining in a paste-like form or a rubber-like form even after anaerobic thickening at room temperature.

### [Thermally Conductive Filler (D)]

In the case of using the present paste as a heat-dissipating paste, the present paste preferably contains a component (D).

In the case of using the component (D) in the present paste, the component (D) to be used may be one kind or two or more kinds. In the case of using two or more kinds of components (D), two or more kinds of components (D) having different materials may be used, or two or more kinds of components (D) having different shapes or average particle diameters may be used, for example.

As the component (D), a filler having a heat conductivity of 1 W/m·K or more is preferably used.

Examples of such a component (D) include metal powder, metal oxide powder, metal nitride powder, metal hydroxide powder, metal oxynitride powder, metal carbide powder, and carbon materials, and specific examples thereof include aluminum oxide (Al₂O₃), silicon oxide (SiO₂), magnesium oxide (MgO), beryllium oxide (BeO), zinc oxide (ZnO), silicon nitride (Si₃N₄), boron nitride (for example: hexagonal BN or cubic BN), aluminum nitride (AlN), silicon carbide (SiC), graphite, diamond, and carbon nanotubes.

The shape of the component (D) is not particularly limited, and examples thereof include a granular shape, a scaly shape, and a needle shape, but the shape of the component (D) is preferably a granular shape because the component (D) can be filled at a higher density.

An average particle diameter of the component (D), which has a granular shape is, for example, 0.1 to 100 μm, and is preferably 0.5 to 50 μm. The average particle diameter is a value of d50 in a particle size distribution obtained by a laser diffraction/scattering method (Microtrac method).

When the present paste contains the component (D), the content of the component (D) is preferably 30 to 80 vol % and more preferably 30 to 70 vol % with respect to 100 vol % of the present paste, from the viewpoint that, for example, a paste having a low initial viscosity and more excellent heat dissipation performance can be easily obtained.

Note that the greater the blending amount of component (D), the better the thermal properties (for example: an increase in thermal diffusion value and a decrease in thermal resistance value) tend to be, for example, when used as a heat-dissipating material, and therefore, depending on the application, a large amount of component (D) may be blended. However, in conventional pastes, when the blending amount of the component (D) is increased, the initial viscosity increases, and workability deteriorates (it becomes difficult to form a paste at a predetermined location by, for example, coating or pouring). Thus, in conventional pastes, it has been difficult to blend a large amount of component (D).

On the other hand, since the present paste has a low initial viscosity, according to the present paste, even when the blending amount of the component (D) is increased, workability hardly deteriorates.

Therefore, according to one embodiment of the present invention, even when the component (D) is blended in an amount of preferably 40 to 80 vol % and more preferably 50 to 70 vol % with respect to 100 vol % of the present paste for the purpose of obtaining a paste having particularly excellent thermal properties, a paste having a low initial viscosity and excellent workability can be obtained.

### [Stabilizer]

The stabilizer is not particularly limited, but it is preferable to use a stabilizer that enhances the storage stability of the present paste.

In the case of using the stabilizer in the present paste, the stabilizer to be used may be one kind or two or more kinds.

Examples of the stabilizer include a metal ion sealing agent or a polymerization inhibitor, and specific examples thereof include chelating agents such as disodium ethylenediaminetetraacetate dihydrate (EDTA2Na) and tetrasodium ethylenediaminetetraacetate tetrahydrate (EDTA4Na); and polymerization inhibitors such as dibutylhydroxytoluene (BHT), p-hydroxytoluene, hydroquinone (HQ), di-tert-butylhydroquinone (DTBHQ), mono-tert-butylhydroquinone (MTBHQ), 1,4-naphthoquinone, tert-butylhydroxyanisole, p-hydroxyanisole, benzoic acid, 2,5-dihydroxybenzoic acid, 2,5-dihydroxyterephthalic acid, toluic acid, catechol, t-butylcatechol, 4-allylcatechol, 4-acetylcatechol, 2-methoxyphenol, p-methoxyphenol, 2-ethoxyphenol, 2-methoxy-4-(2-propenyl)phenol, 3,4-dihydroxybenzaldehyde, 2,3-dihydroxybenzaldehyde, benzylamine, 1,1,3-tris(2-methyl-4-hydroxy-5-tert-butylphenyl)butane, tert-butylhydroxyaniline, p-hydroxyaniline, and propyl gallate.

When the present paste contains a stabilizer, a content of the stabilizer is preferably 0.01 to 3.0 parts by mass and more preferably 0.1 to 2.0 parts by mass with respect to 100 parts by mass of the component (A) from the viewpoint of easily obtaining a paste having excellent storage stability.

### [Catalyst]

The catalyst is not particularly limited, but a catalyst that promotes an anaerobic reaction is preferably used.

In the case of using the catalyst in the present paste, the catalyst to be used may be one kind or two or more kinds.

Examples of the catalyst include a metal ion and a catalyst that promotes radical generation from the component (B), and specific examples thereof include an acid and a reducing agent.

Specific examples of the catalyst include saccharin, maleic acid, an amine compound, a mercaptan compound, and a hydrazine derivative.

Examples of the amine compound include heterocyclic secondary amines such as 1,2,3,4-tetrahydroquinoline and 1,2,3,4-tetrahydroquinaldine; heterocyclic tertiary amines such as quinoline, methylquinoline, quinaldine, and quinoxaline phenazine; aromatic tertiary amines such as N,N-dimethylanisidine, N,N-dimethylaniline, and N,N-dimethyl-p-toluidine (DMPT); aromatic secondary amines such as N,N′-1,4-phenylenebis(5-methyl-2-hexylamine); and azole-based compounds such as 1,2,4-triazole, oxazole, oxadiazole, thiadiazole, benzotriazole, hydroxybenzotriazole, benzothiazole, benzoxazole, 1,2,3-benzothiadiazole, and 3-mercaptobenzotriazole.

Examples of the mercaptan compound include linear mercaptans such as n-dodecyl mercaptan, ethyl mercaptan, butyl mercaptan, and 2-mercaptoethanol.

Examples of the hydrazine derivative include methyl carbazate, 1-acetyl-2-phenylhydrazine (APH), nitrophenylhydrazine (NPH), and p-trisulfonylhydrazide.

When the present paste contains a catalyst, a content of the catalyst is preferably 0.01 to 1.0 part by mass and more preferably 0.01 to 0.1 parts by mass with respect to 100 parts by mass of the component (A) from the viewpoint that, for example, a paste that readily undergoes anaerobic thickening at room temperature can be easily obtained.

### <Method for Preparing Present Paste>

The present paste can be prepared by, for example, mixing the components (A) and (B), and, if necessary, the other components used as needed, and kneading and dispersing the mixture using, for example, a mixer or a roll.

### <Physical Properties of Present Paste>

An initial shear viscosity (this viscosity corresponds to an initial viscosity) at 23° C. of the present paste measured with a cone-plate type viscometer (rotational speed: 0.5 rpm) is preferably low, and specifically, is preferably 500 Pa·s or less, more preferably 100 Pa·s or less, particularly preferably 50 Pa·s or less, and is preferably 1 Pa·s or more.

When the initial viscosity of the present paste is within the above range, a paste having excellent workability (easily forming a paste at a predetermined location by, for example, coating or pouring) can be easily obtained. When such a paste having a low initial viscosity is a heat-dissipating paste, for example, since a paste layer having a small thickness can be easily formed at a predetermined location such as between a heating element and a heat-dissipating member and easily conforms to a mating surface of, for example, a heating element or a heat-dissipating member, heat resistance resulting from the paste layer can be reduced, and an electronic component having excellent heat dissipation characteristics can be easily obtained, for example.

Although a paste having a low initial viscosity usually tends to undergo pump-out even after thickening, according to one embodiment of the present invention, even a paste having a low initial viscosity can suppress pump-out after anaerobic thickening at room temperature.

When 4 g of the present paste is sandwiched between two copper plates at 23° C. and compressed for 2.5 hours so as to have a thickness of 0.4 mm, a shear viscosity (viscosity after anaerobic thickening at room temperature) of the compressed material (paste) is preferably 1.5 times or more, more preferably 3 times or more, and still more preferably 10 times or more relative to the shear viscosity (initial viscosity) of the paste before anaerobic thickening at room temperature. Note that when the compressed material is in a rubber-like form, the shear viscosity (viscosity after anaerobic thickening at room temperature) of the compressed material becomes substantially infinitely greater than the initial viscosity, and thus, can be regarded as falling within the above range.

When the ratio of the viscosity after anaerobic thickening at room temperature to the initial viscosity is within the above range, a paste having an excellent balance between a low initial viscosity and suppression of pump-out can be easily obtained.

The viscosity after anaerobic thickening at room temperature is preferably a viscosity such that the ratio of the viscosity after anaerobic thickening at room temperature to the initial viscosity falls within the above range, but, specifically, is preferably 20 Pa·s or more, more preferably 40 Pa·s or more, and still more preferably 50 Pa·s or more, from the viewpoint that, for example, the pump-out can be suppressed, and in the case of using the present paste in applications in which suppression of pump-out is extremely important, a specific value of the viscosity after anaerobic thickening at room temperature is, for example, preferably 500 Pa·s or more, more preferably 1,000 Pa·s or more, and particularly preferably 1,500 Pa·s or more.

When the viscosity after anaerobic thickening at room temperature is within the above range, pump-out can be easily suppressed after anaerobic thickening at room temperature due to flow resistance.

Note that the viscosity after anaerobic thickening at room temperature is specifically a viscosity measured by a method described in the following Examples.

### <Applications of Present Paste>

The present paste can be used without limitations in applications in which the conventional paste has been used; however, from the viewpoint that, for example, the effects of the present invention are more exhibited, the paste can be suitably used in applications in which there is a possibility of exposure to high temperatures (for example: 200° C. or higher), in applications in which it is difficult to heat or irradiate with light the paste disposed at a predetermined location, and particularly in applications in which the paste is required to have a low viscosity when forming the paste at the predetermined location by, for example, coating or pouring, and to remain in a paste-like form or a rubber-like form at the predetermined location after anaerobic thickening at room temperature.

Specific examples of the applications include use for members such as a sliding member, a brake member, and a vibration damping and absorbing member, and examples of the present paste containing the component (D) include use as a heat-dissipating paste used between a heating element and a heat-dissipating member in, for example, an electronic component. Examples of the applications in which suppression of pump-out is extremely important include those for the heat-dissipating paste.

Note that it is preferable that at least a part of a member in contact with the present paste (for example: a sliding member, a brake member, a vibration damping and absorbing member, a heating element, or a heat-dissipating member) (at least in a portion where the member is in contact with the present paste) is formed of metal.

In particular, the present paste containing the component (D) is a paste having a low initial viscosity and, after anaerobic thickening at room temperature, suppressed in, for example, pump-out, base oil bleeding, solidification, and dripping, and since heat dissipation performance (thermal conductivity) can be maintained over a long period of time, the paste can be suitably used in, for example, devices, equipment, and components having a heating element. By using the present paste for these, it is possible to obtain, for example, devices, equipment, and components having excellent long-term reliability. In particular, since the paste has a low initial viscosity and conforms well with a heating element and a heat-dissipating member, a thin paste layer can be formed between the heating element and the heat-dissipating member, and since heat resistance due to the paste layer can be reduced, the paste is suitably used as a heat-dissipating paste provided between the heating element and the heat-dissipating member. Moreover, since the paste does not solidify, is hard to crack, and can absorb (suppress) vibrations, the paste is suitably used as a heat-dissipating paste for semiconductor devices such as power modules and as a heat-dissipating paste for vehicles such as automobiles and particularly suitably used as a heat-dissipating paste for power modules.

Examples of the method for forming the present paste at a predetermined location include a method in which the present paste is applied to a predetermined location by a conventionally known coating method, and a method in which the present paste is poured into a predetermined location. When the present paste is formed between two members, it is preferable to apply or pour the paste between the members and then apply pressure. In this case, heating may be performed as necessary. For example, when the present paste is to be formed between a heating element and a heat-dissipating member, in consideration of heat resistance, the thickness of the present paste (layer) is preferably thin. Therefore, in this case, it is preferable to form the present paste between the heating element and the heat-dissipating member and then apply pressure thereto to stretch the present paste.

### EXAMPLES

Hereinafter, one embodiment of the present invention will be described in more detail with reference to Examples, but the present invention is not limited to these Examples.

### Examples 1 to 17 and Comparative Examples 1 to 3

Anaerobic pastes were prepared by mixing the respective components shown in Table 1 in the blending ratios (the units of the numerical values are in parts by mass) shown in Table 1.

Details of each component in Table 1 are as shown in Table 2.

Note that the “functional group ratio” in Table 1 is a value calculated from the following Formula (5). For example, “E-04” indicates “10-4”.

$$Functional group ratio = ( Blending amount of polysiloxane / Functional group equivalent of polysiloxane ) \times ( Blending amount of initiator / Active oxygen equivalent of initiator ) \qquad ( 5 )$$

The blending amount of the polysiloxane in Formula (5) is 100 parts by mass, and the blending amount of the initiator is the blending amount of the initiator with respect to 100 parts by mass of the blending amount of the polysiloxane. Note that when two types of polysiloxanes are used, the total blending amount thereof is 100 parts by mass.

### <Initial Viscosity>

The prepared anaerobic paste was allowed to stand in air at room temperature for 1 day in order to stabilize physical properties, and then, the viscosity (initial viscosity) at 23° C. was measured using a cone-plate type viscometer (HBDVNextCP [manufactured by Brookfield Corporation]) under a condition of a rotational speed of 0.5 rpm. The results are shown in Table 1.

<Viscosity after Anaerobic Thickening at Room Temperature>

The prepared anaerobic paste was allowed to stand in air at room temperature for 1 day in order to stabilize physical properties, and then, 4 g of the anaerobic paste was sandwiched between two copper plates (tough pitch copper C1100P [manufactured by Hakudo Co., Ltd.]) at 23° C., and compressed with a shim for 2.5 hours so that the thickness of the paste was 0.4 mm. Next, the shear viscosity of the anaerobic paste after compression was measured at a rotational speed of 0.5 rpm using a cone-plate type viscometer (HBDVNextCP [manufactured by Brookfield Corporation]). Note that when the viscosity was measured at a rotational speed of 0.5 rpm using a cone-plate type viscometer and the measurement upper limit viscosity was exceeded, the rotational speed was changed to 0.1 rpm and the measurement was performed. The results are shown in Table 1.

Note that when the measurement upper limit viscosity is exceeded even when the rotational speed is changed to 0.1 rpm, “>8,000” is shown in Table 1.

<Properties after Anaerobic Thickening at Room Temperature>

The prepared anaerobic paste was allowed to stand at room temperature for 1 day in order to stabilize physical properties, and then, 4 g of the anaerobic paste was sandwiched between two copper plates (tough pitch copper C1100P [manufactured by Hakudo Co., Ltd.]) at 23° C., and compressed with a shim for 2.5 hours so that the thickness of the paste was 0.4 mm, thereby obtaining a compressed material. 0.2 g of the compressed material obtained using the anaerobic paste prepared in each of Examples 2, 4 to 15, and 17 and Comparative Examples 1 to 3 was formed into a 5 mm square, and the thickness when compressed at 23° C. under a pressure of 1.0 MPa was measured. The compression conditions are as follows.

In addition, for the compressed materials obtained using the anaerobic pastes prepared in Examples 1, 3, and 16, the surface Martens hardness was measured at a maximum test force of 0.3 mN by an ultra-micro hardness tester (DUH-211 [manufactured by Shimadzu Corporation]) using a triangular pyramid indenter (apex angle: 115°) as a measurement indenter.

The case where the thickness of the compressed material measured using the anaerobic paste prepared in each of Examples 2, 4 to 15, and 17 and Comparative Examples 1 to 3 was 200 μm or less was evaluated as 0 (paste-like form), and the case where the measured thickness of the compressed material exceeded 200 μm was evaluated as X (not in paste-like form).

In addition, for the compressed materials obtained using the anaerobic pastes prepared in Examples 1, 3, and 16, the case where the surface Martens hardness was 10 N/mm² or less was evaluated as O (rubber-like form), and the case where the measured surface Martens hardness of the compressed material exceeded 10 N/mm² was evaluated as X (solidified (=not in rubber-like form)).

The results are shown in Table 1.

### <Storage Preservability>

The prepared anaerobic paste was allowed to stand in air at room temperature for 5 days, 0.2 g of the anaerobic paste was then formed into a 5 mm square, and the thickness was measured when compressed at 23° C. at a pressure of 1.0 MPa. The compression conditions are as follows.

The case where the measured thickness of the anaerobic paste was 200 μm or less was evaluated as 0 (paste-like form), and the case where the measured thickness of the anaerobic paste exceeded 200 μm was evaluated as X (not in paste-like form). The results are shown in Table 1.

### <Conditions of Compression>

The anaerobic paste was compressed by stretching 0.2 g of the anaerobic paste on a metal disk into a 5 mm square, sandwiching the anaerobic paste with another metal disk, and then applying a predetermined load to the sample by tightening a screw with a torque wrench.

The thickness was measured by measuring lengths (lengths without sample) of both ends of two metal disks in a state where the two metal disks were stacked and loaded at 1 MPa in advance, measuring lengths (lengths with sample) of both ends of the two metal disks in a state where the sample was sandwiched, and then subtracting the length without sample from the length with sample.

Note that, in consideration of the change in thickness due to compression, the thickness was measured 3 minutes after compression.

Pressure sample holder (Flash analyzer LFA467 accessory, manufactured by NETZSCH Japan K.K.) and a torque wrench were used at the time of applying the pressure, and LITEMATIC VL-50 (manufactured by Mitutoyo Corporation) was used for the measurement of the thickness.

As the metal disk, a copper plate (tough pitch copper C1100P [manufactured by Hakudo Co., Ltd.]) was used in the property test after anaerobic thickening at room temperature, and a plate formed of SUS304 as a material, having a diameter of 14 mm, a thickness of 3 mm, and a surface roughness Ra of 0.2 was used in the storage preservability test.

TABLE 1

| | Example | | | | | | | | | |
|---|---|---|---|---|---|---|---|---|---|---|
| | 1 | 2 | 3 | 4 | 5 | 6 | 7 | 8 | 9 | 10 |
| Polysiloxane A1 | 100 | 100 | 50 | 30 | 10 | 10 | 10 | 10 | 5 | 5 |
| Polysiloxane A2 | | | 50 | 70 | 90 | 90 | 90 | 90 | 95 | 95 |
| Polysiloxane | | | | | | | | | | |
| Redox initiator B1 | 3 | 1 | 5 | 5 | 5 | 2 | 2 | 2 | 1.5 | 2 |
| Redox initiator B2 | | | | | | | | | | |
| Non-redox initiator | | | | | | | | | | |
| Compound 1 | | | | | | | 6 | | | |
| Compound 2 | | | | | | | | 6 | 8 | 4 |
| Catalyst 1 | | | | | | | | | 0.02 | |
| Catalyst 2 | | | | | | | | | 0.02 | |
| Stabilizer 1 | | | | | | | | | 0.25 | 0.25 |
| Stabilizer 2 | | | | | | | | | 0.25 | |
| Stabilizer 3 | | | | | | | | | | 0.25 |
| Filler 1 | 300 | 300 | 300 | 300 | 300 | 300 | 300 | 300 | 300 | 300 |
| Filler 2 | | | | | | | | | | |
| Filler 3 | | | | | | | | | | |
| Total | 403 | 401 | 405 | 405 | 405 | 402 | 408 | 408 | 410.04 | 406.5 |
| Functional group ratio | 8.51E−04 | 2.84E−04 | 7.54E−04 | 4.88E−04 | 2.23E−04 | 8.90E−05 | 8.90E−05 | 8.90E−05 | 4.69E−05 | 6.25E−05 |
| Initial viscosity (Pa · s) | 16 | 16 | 98 | 133 | 29 | 33 | 75 | 97 | 14 | 37 |
| Viscosity after | >8000 | 324 | >8000 | 7858 | 503 | 256 | 451 | 194 | 98 | 111 |
| anaerobic thickening at | | | | | | | | | | |
| room temperature | | | | | | | | | | |
| (Pa · s) | | | | | | | | | | |
| Properties after | ◯ | ◯ | ◯ | ◯ | ◯ | ◯ | ◯ | ◯ | ◯ | ◯ |
| anaerobic thickening at | | | | | | | | | | |
| room temperature | | | | | | | | | | |
| Storage preservability | ◯ | ◯ | ◯ | ◯ | ◯ | ◯ | ◯ | ◯ | ◯ | ◯ |

| | Example | | | | | | | Comparative Example | | |
|---|---|---|---|---|---|---|---|---|---|---|
| | 11 | 12 | 13 | 14 | 15 | 16 | 17 | 1 | 2 | 3 |
| Polysiloxane A1 | 20 | 100 | 100 | 100 | 100 | 100 | 100 | | 100 | |
| Polysiloxane A2 | 60 | | | | | | | | | 100 |
| Polysiloxane | 20 | | | | | | | 100 | | |
| Redox initiator B1 | 2 | 3 | 1 | | | 1 | 1 | 5 | | |
| Redox initiator B2 | | | | 3 | 1 | | | | | |
| Non-redox initiator | | | | | | | | | 5 | |
| Compound 1 | | | | | | | | 2 | 2 | 2 |
| Compound 2 | 4 | | | | | | | | | |
| Catalyst 1 | | | | | | | | | | |
| Catalyst 2 | | | | | | | | | | |
| Stabilizer 1 | 0.25 | | | | | | | | | |
| Stabilizer 2 | | | | | | | | | | |
| Stabilizer 3 | 0.25 | | | | | | | | | |
| Filler 1 | 300 | | | 300 | 300 | | | 300 | 300 | 300 |
| Filler 2 | | | | | | 110 | | | | |
| Filler 3 | | | | | | | 300 | | | |
| Total | 406.5 | 103 | 101 | 403 | 401 | 211 | 401 | 407 | 407 | 402 |
| Functional group ratio | 1.35E−04 | 8.51E−04 | 2.84E−04 | 4.06E−04 | 1.35E−04 | 2.84E−04 | 2.84E−04 | 0 | 1.81E−03 | 0 |
| Initial viscosity (Pa · s) | 14 | 2 | 2 | 14 | 16 | 395 | 62 | 213 | 10 | 14 |
| Viscosity after | 343 | 152 | 24 | 6795 | 262 | >8000 | 708 | 216 | 10 | 14 |
| anaerobic thickening at | | | | | | | | | | |
| room temperature | | | | | | | | | | |
| (Pa · s) | | | | | | | | | | |
| Properties after | ◯ | ◯ | ◯ | ◯ | ◯ | ◯ | ◯ | ◯ | ◯ | ◯ |
| anaerobic thickening at | | | | | | | | | | |
| room temperature | | | | | | | | | | |
| Storage preservability | ◯ | ◯ | ◯ | ◯ | ◯ | ◯ | ◯ | ◯ | ◯ | ◯ |

TABLE 2

| | |
|---|---|
| Polysiloxane A1 | KF-2001 (manufactured by Shin-Etsu Chemical Co., Ltd., polysiloxane having mercapto group, functional group |
| | equivalent: 1,900 g/mol) |
| Polysiloxane A2 | KF-2004 (manufactured by Shin-Etsu Chemical Co., Ltd., polysiloxane having mercapto group, functional group |
| | equivalent: 30,000 g/mol) |
| Polysiloxane | KF-96-100cs (manufactured by Shin-Etsu Chemical Co., Ltd., dimethylpolysiloxane) |
| Redox initiator B1 | PERCUMYL H-80 (manufactured by NOF Corporation, purity: 82 mass %, active oxygen equivalent: 152.2 g/mol) |
| Redox initiator B2 | PERCUMYL P (manufactured by NOF Corporation, purity: 50 mass %, active oxygen equivalent: 194.3 g/mol) |
| Non-redox initiator | PERHEXA 25B (manufactured by NOF Corporation, purity: 100 mass %, active oxygen equivalent: 145.2 g/mol) |
| Compound 1 | TAIC (manufactured by Mitsubishi Chemical Corporation, triallyl isocyanurate, functional group equivalent: 83.1 g/mol) |
| Compound 2 | Hi-Cross M (manufactured by Seiko Chemical Co., Ltd., trimethylolpropane trimethacrylate, functional group equivalent: |
| | 112.8 g/mol) |
| Catalyst 1 | Saccharin (manufactured by Tokyo Chemical Industry Co., Ltd., o-sulfobenzimide) |
| Catalyst 2 | APH (manufactured by Tokyo Chemical Industry Co., Ltd., 1-acetyl-2-phenylhydrazine) |
| Stabilizer 1 | EDTA2Na (manufactured by Tokyo Chemical Industry Co., Ltd., disodium ethylenediaminetetraacetate dihydrate) |
| Stabilizer 2 | p-Methoxyphenol (manufactured by Tokyo Chemical Industry Co., Ltd., 4-methoxyphenol) |
| Stabilizer 3 | BHT (manufactured by Tokyo Chemical Industry Co., Ltd., butyl hydroxytoluene) |
| Filler 1 | Advanced alumina AA-1.5 (manufactured by Sumitomo Chemical Co., Ltd., alumina powder) |
| Filler 2 | Agglomerates CFA 50M (manufactured by 3M Company, boron nitride powder) |
| Filler 3 | RF-10CS-SC (manufactured by Ube Material Industries, Ltd., magnesium oxide powder) |

1. An anaerobic paste comprising: a polysiloxane (A) having a mercapto group; and a redox initiator (B),
wherein the anaerobic paste thickens at room temperature under conditions of being in contact with a metal member and under anaerobic conditions, and is in a paste-like form or a rubber-like form after thickening.

2. The anaerobic paste according to claim 1, wherein an initial shear viscosity at 23° C. is 500 Pa·s or less.

3. The anaerobic paste according to claim 1, wherein a functional group ratio represented by the following Formula (1) is 1.0×10⁻³ or less,
$$functional group ratio = ( a blending amount of the polysiloxane ( A ) / a functional group equivalent of the polysiloxane ( A ) ) \times ( a blending amount of the redox initiator ( B ) / an active oxygen equivalent of the redox initiator ( B ) ) . \qquad ( 1 )$$

4. The anaerobic paste according to claim 1, comprising a thermally conductive filler (D).

5. The anaerobic paste according to claim 4, wherein a content of the thermally conductive filler (D) is 30 to 80 vol % with respect to 100 vol % of the anaerobic paste.
